(19) United States
(12) Patent Application Publication
(10) Pub. No.: US 2020/0364498 A1
(43) Pub. Date: Nov. 19, 2020

(54) AUTONOMOUS BURNER

(71) Applicant: Schlumberger Technology Corporation, Sugar Land, TX (US)

(72) Inventors: Hugues Trifol, Clamart (FR); Hakim Arabi, Beijing (CN)

(21) Appl. No.: 16/561,844

(22) Filed: Sep. 5, 2019

Related U.S. Application Data
(60) Provisional application No. 62/848,307, filed on May 15, 2019.

(51) Int. Cl. G06K 9/62; E02B 15/04; F23G 7/05; F23N 5/18; G06N 3/02

(52) U.S. Cl. CPC G06K 9/6231; E02B 15/042; G06N 3/02; F23G 7/05; F23N 5/184; G06K 9/6257

(57) ABSTRACT

Methods of autonomously controlling hydrocarbon burners described herein include capturing an image, for example from a video feed, of an operating burner; processing the image to form an image data set; capturing sensor data of the operating burner; forming a data set comprising the sensor data and the image data set; providing the data set to a machine learning model system; outputting, from the machine learning model system, an air control parameter of the burner; and applying the air control parameter to the burner.

### CROSS-REFERENCE TO RELATED APPLICATIONS

This application claims priority to U.S. Provisional Patent Application No. 62/848,307 filed May 15, 2019, which is herein incorporated by reference.

### BACKGROUND

### Field

Embodiments described herein generally relate to burners for excess hydrocarbon. Specifically, embodiments described herein relate to control of combustion in such burners.

### Description of the Related Art

The global oil and gas industry is trending toward improved environmental safety and compliance throughout the various phases of a well lifecycle. Exploration and production involves dynamic well testing that can produce a large amount of hydrocarbons at the surface. Excess hydrocarbons cannot be stored, so the most economical viable option is often to dispose of the excess hydrocarbons by flaring. This is even more relevant for offshore operations.

Combustion of hydrocarbon will typically result in some environmental impact, even for clean burner operation without visible fallout and smoke. Most of the environmental impacts are created by spill and fallout. This can be due to incomplete combustion from change in fluid, poor burner operating parameters, and/or poor monitoring. The startup and shut down phases are critical and need to be monitored closely which requires good human communication and interaction.

Even the best burner needs constant monitoring and air supply adjustment during such operations to maintain acceptable combustion through variation in fluid properties, flowrates, and weather conditions.

For the continuous burning phase which can last for days the monitoring and regulation of air supply to the burner becomes difficult. Failing to monitor the combustion and adjust the air supply according to the flame or smoke appearance will have immediate impact on the combustion quality and emissions from the burner. Improved methods of monitoring and control of hydrocarbon burners is needed.

### SUMMARY

Embodiments described herein provide methods of autonomously controlling hydrocarbon burners, including capturing an image of an operating burner; processing the image to form an image data set; capturing sensor data of the operating burner; forming a data set comprising the sensor data and the image data set; providing the data set to a machine learning model system; outputting, from the machine learning model system, an air control parameter of the burner; and applying the air control parameter to the burner.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 is a system diagram of a burner control system according to one embodiment.

FIG. 2 is a system diagram of a burner control system according to another embodiment.

FIG. 3 is a system diagram of a burner control system according to another embodiment.

FIG. 4 is a flow diagram summarizing a method according to another embodiment.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

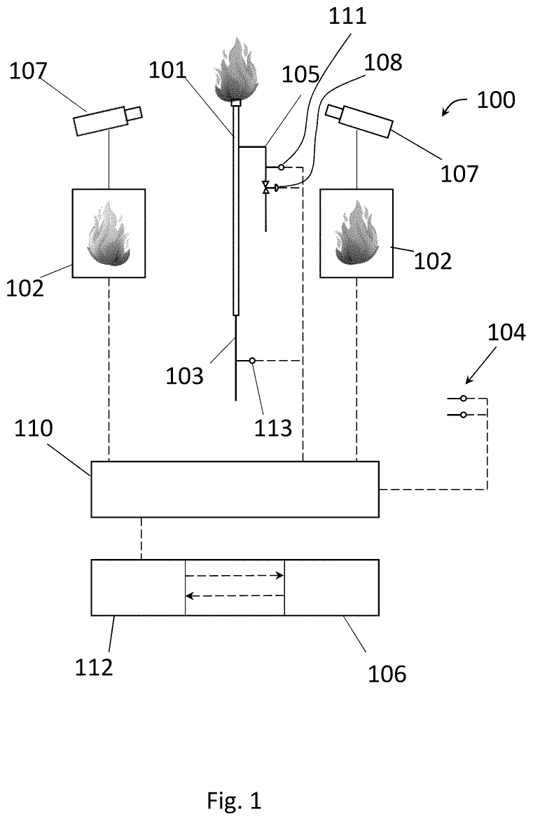

FIG. 1 is a system diagram of a burner control system 100 according to one embodiment. The burner 100 includes at least one camera 107 positioned to capture an image 102 of a flare emitted by a burner 101. Here, two cameras 107 are shown capturing images 102 from different locations to get image data from more than one image plane of the flare. The burner 101 has a fuel feed 103 that flows fuel to the burner 101. The burner 101 also has an air feed 105 that flows air to the burner 101. Flow rate of the air feed is controlled by a control valve 108, and an air flow sensor 111 senses flow rate of air into the burner 101. A fuel flow sensor 113 senses flow rate of fuel to the burner 101. Other sensors 104, along with the at least one camera 107, are operatively coupled to a neural network model 106. The sensors 104 may sense, and produce signals representing, combustion effective parameters such as temperature, wind speed, and ambient humidity. The sensors 104, 111, and 113, and the cameras 107 send data, including data representing the images 102, along with data representing readings of the sensors 104, 111, and 113, to the neural network model 106. The data sent to the neural network model 106 represent a state of the combustion taking place at the burner 101. The neural network model 106 predicts air control parameters based on the data from the sensors 104, 111, and 113 and the at least one camera 107. The air control parameters are applied to a control valve 108 that controls air supply to the burner depicted in the image 102.

“Camera,” as used herein, means an imaging device. A camera captures an image of electromagnetic radiation in a medium that can be converted to data for use in digital processing. The conversion can take place within the camera or in a separate processor. The camera may capture images in one wavelength or across a spectrum, which may encompass the ultraviolet (UV) spectrum, the visible spectrum, and/or the infrared spectrum. For example, the camera may capture an image of wavelengths from 350 nm to 1,500 nm. Broad spectrum imaging devices such as LIDAR detectors, and narrower spectrum detectors such as charged-coupled device arrays and short-wave infrared detectors can be used as imaging devices. Cameras can be monovision or stereo cameras.

An image processing unit 110 can be coupled to the neural network model 106 to provide a data set representing the images 102 captured by the at least one camera 107. The data set, along with sensor data representing oil flow rate, gas flow rate, water or steam flow rate, air flow rate, pressure, temperature, wind speed, ambient humidity, and other combustion effective parameters, are all sent to the neural network model 106 as input. The neural network model 106 receives the input data and outputs one or more air control parameters, such as flow rate, pressure, and/or temperature, for each burner controlled by the control system. Thus, one neural network model can control more than one burner. Air control parameters output by the neural network model 106 can be stored in digital storage for later analysis. The air control parameters are transmitted to control valves that control air supply to the burners controlled by the control system. Subsequent images and sensor data acquisitions are captured, and the control cycle repeated as many times as desired. Frequency of repetition depends on the various time constants of the control system, but may be as short as every fraction of a second or as long as once every five to ten minutes. In one example, several images are captured every second in a video feed and the control cycle of computing air control parameters and applying the computed air control parameters to a control valve controlling air supply to the burner is repeated for every image contained in the video. The video may be live, limited only by transmission and minimum processing time, or the video may be deliberately delayed by any desired amount.

The image processing unit 110 converts signals derived from photons received by the cameras 107 into data. The image processing unit 110 may be within the camera 107 or separate from the camera 107. Here, a separate image processing unit 110 is shown operatively coupled to two cameras 107 to process imaged received from both cameras 107. The image processing unit 110 converts the signals received from the cameras 107 into digital data representing photointensity in defined areas of the image and assigns position information to each digital data value. The photointensity may be deconvolved into constituent wavelengths by known methods to produce a spectrum for each pixel. This spectrum may be sampled in defined bins, and the data from such sampling structured into a data set representing spectral intensity of the received image as a function of x-y position in the image. A time-stamp can also be added.

FIG. 1 shows a burner control system 100 in training mode. A training manager unit 112 operatively connects and communicates with the neural network model 106 to manage training of the model 106 and, optionally, structuring of data to provide to the model. The training manage unit 112 may include data conditioning portions that can remove outlier data, based for example on statistical analysis or other input. For example, statistical analysis can show that certain data deviates from a norm by a statistically significant margin. Other data can define a period of operation encompassing certain sensor or image data as abnormal. The training manager unit 112 can remove sensor and/or image data based on various definitions of abnormal operation.

The training manager unit 112 also determines adjustments to the neural network model 106 based on outputs from the model 106. Sensor and image data, processed and structured for use by the model 106, is provided to the model 106. The neural network model 106 outputs air control parameters, which can be stored in digital storage and assessed for quality of the output. The output from the neural network model 106 is provided to the training manager unit 112 for assessment. High quality output is assessed highly, for example by assigning a high score to the output, whereas low quality output is assessed at a low level, for example with a low score. The air control parameters output by the neural network model 106 can compared to actual air control parameters received from the burner and related to a corresponding image of the burner flame that forms the basis for the output. An error can be computed and used to assess the quality of the neural network model 106 output. For example, the neural network model can be used to model what air control parameters give rise to the present input data, including sensor data and image data. The modeled air control parameters can be compared to actual air control parameters to determine quality of the neural network model output. A weight adjustment can be applied to the error for purposes of training the neural network model. For example, if the neural network model produced an error of “e,” the output of the next iteration of the neural network model can be adjusted by “-e” or by “-we,” where w is a weighting adjustment. The weighting adjustment generally determines how fast the system attempts to correct for errors. The weighting adjustment may also respond to a change in error (derivative) or an accumulation of error (integral), in addition to proportion. In this way, the neural network improves its predictions autonomously.

The training manager unit 112 can also compute changes to the parameters of the model 106 and applies those changes to the model. In one example, the edge weights of the neural network model 106 can be adjusted according to the error defined above. Edge weights that contributed most to the result can be adjusted the most, while those contributing the least can be adjusted least. In a simple example, a correction factor can be computed as edge weight times activation factor times normalized error, and the correction factor can be subtracted from the edge weights. In a more complex example, a linear combination of time-series errors can be used to compute the correction factor. Activation factors can also be updated similarly.

In addition to removing outliers, the training manager unit 112 can condition the input data for training the neural network. Images can be filtered, normalized, compressed, pixelated, interpolated, and/or smoothed, and outliers can be rejected outright. An image can be converted to numeric form pixel-by-pixel, recording the wavelength of light captured in the pixel and the brightness. Alternately, the light received in each pixel can be recorded as a spectrum, with individual values representing brightness of the pixel at selected wavelengths. Other data, such as environmental conditions, air quality, and fuel flow rates, can also be included in the input data set for training the neural network.

The neural network can operate in training mode periodically to refocus the model with new parameters. For example, the neural network can automatically switch to training mode after a set number of control cycles, for example 1,000 control cycles or 10,000 control cycles. Alternately, the neural network can automatically switch to training mode after a set time, for example once per day or once per week. In each case, the neural network tests the output of its predictions using current model parameters, such as topologies and weighting adjustment factors, and adjusts those factors to improve the result. Training mode can persist according to any convenient criteria. For example, training mode can persist until a specific accuracy level is reached. Alternately, training mode can persist for a set period of time, so long as results are improving. In the event the training mode algorithm cannot find a way to improve the model result, the training mode can be automatically discontinued.

Training may be conducted using real-time image data or image data previously collected. The training manager unit 112 may have a predefined training data set stored which it feeds to the neural network model 106 to “train,” or calibrate the model. The training manager unit 112 can also prepare real-time data received from the cameras 107 and the sensors 104, 111, and 113 for submission to the neural network model 106. The training manager unit 112 can also send a combination of real-time and pre-recorded data to the neural network model 106 to calibrate the model 106.

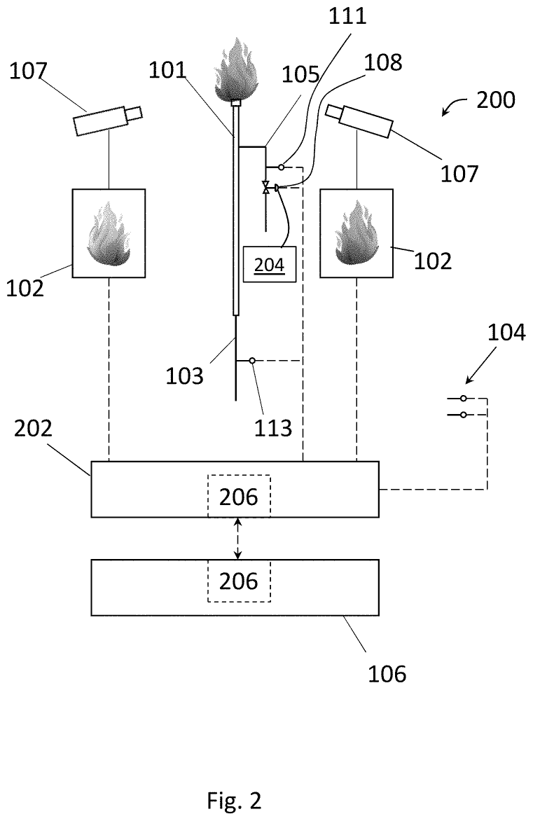

FIG. 2 is a system diagram of a burner control system 200 according to another embodiment. FIG. 2 illustrates the control system in an operating mode. The one or more cameras 107 send one or more image data sets 102 to the neural network model 106. Sensor data is also sent to the neural network model. The neural network model 106, operating based on results obtained in training mode, computes and outputs air control parameters to a controller 202, which in turns signals the control valve 108 to control air flow to the burners under control. The control valve 108 may be pneumatically actuated, so the controller 202 signals an air supply actuator 204 to control air supply to the control valve 108 to operate the control valve 108. Alternately, the control valve 108 may be electrically actuated. As noted above, the control cycle can repeat at any desired frequency. Air control parameter output of the neural network model can be filtered if desired to prevent any extreme changes being made to air flow. Tuning of the neural network model to compensate for system dead times and noise can also improve results.

In the burner control system 200, no training manager unit operates between the controller 202 and the neural network model 106. The neural network model 106 receives image and sensor data from the controller 202 and computes an output applying the model to the input. The output is applied to the control valve 108 by the controller.

It should be noted that the controller 202 may be configured to condition the output of the neural network model 106 before application to the control valve 108. For example, the controller 202 may filter the output according to any rules, such as rate or magnitude of change rules, delay rules, acceptance rules, or any other rules. Standard PID rules can be used in applying the output of the neural network model 106 to the control valve 108. In other cases, limit rules can apply, either to the output itself or the change in the output. The limit rules can be configured to ignore the output altogether, effectively skipping a control cycle and leaving the control valve 108 position unchanged, or the limit rules can be configured to adopt some value partially representative of the neural network model 106 output. For example, if the output of the model 106 represents a change too large to be allowed by limit rules, a portion of the change, which can be fixed or determined in relation to how far the change exceeds the allowed limit, can be implemented.

The controller 202 may include an output acceptance section 206 for testing output of the neural network model 106 according to any rules configured in the output acceptance section 206. The output acceptance section 206 may, alternately, be part of the neural network model 106 itself. The output acceptance section 206 may be configured to determine whether an output of the neural network model 206 is acceptable according to predetermined criteria, such as absolute magnitude or magnitude of change. The output acceptance section 206 may also be configured to adjust any output found to violate any of the acceptance criteria. The output acceptance section 206 may also be configured to interrupt and cancel any output found to violate any of the acceptance criteria, resulting in no control action being sent to the air control valve 108. In such cases, the prior set point of the air control valve 108 would continue to control the air control valve 108.

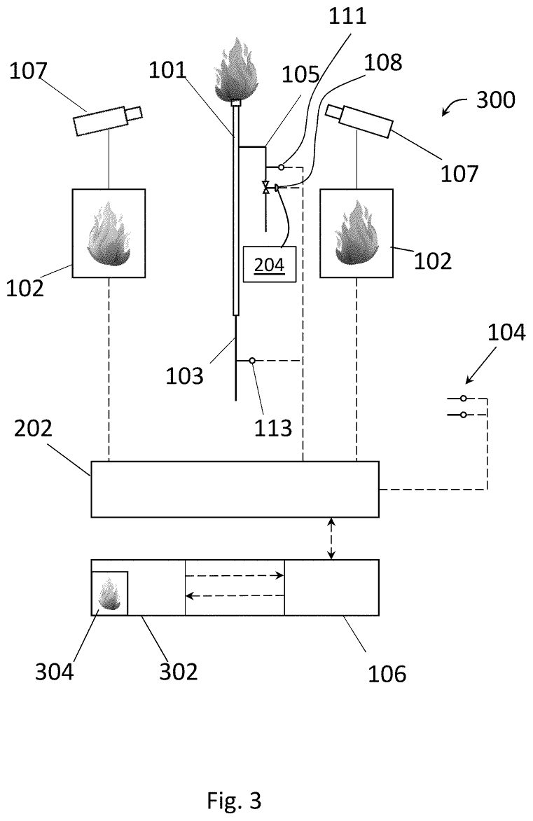

FIG. 3 is a system diagram of a burner control system 300 according to another embodiment. The burner control system 300 is similar to the burner control system 200 in many respects. The burner control system 300 shows a system that is in operating mode, like the burner control system 200. The chief difference is that the burner control system 300 includes a model update unit 302. The model update unit 302 operates to update the parameters of the model 106 on a continuous, semi-continuous, or batch basis. The model update unit 302 includes a standard 304, which is represented here by a flame image, but could be data obtained from a flame image, optionally including sensor and environment data such as air quality data. The model update unit 302 may operate with each cycle of the control loop, based on each image received from any one of the cameras 107, or may operate with every few images received (i.e. semi-continuously), or may operate after a collection of images are received or only upon detection of some deviation in the model 106.

The model update unit 302 compares one or more data sets provided to the neural network model 106 to the standard 304 to determine a deficiency in the control parameter sent to the air control valve 108. A parameter of the image data, or the image data as a whole, can be compared to the standard 304 to determine a score, which can be used to quantify deficiency. For example, average and standard deviation of brightness value at one or more wavelengths can quantify image deviation. Other environment parameters, such as fuel flow, wind, ambient temperature, and the like, can be compensated for statistically or using physical models to achieve a normalized deficiency score for an image. The air flow control output provided by the model 106 can then be assigned an error based on the normalized deficiency. In one example, the error can be back-propagated to the edge weights using a procedure similar to that commonly used to train neural networks. The updated edge weights can then be downloaded to the model 106.

The model update unit 302 can run in parallel with the model 106. Thus, the model 106 runs for every image received from one of the cameras 107 while the model update unit 302 runs in parallel to the model processing. When the model update unit 302 has new edge weights, model processing can be suspended briefly while the new edge weights are downloaded to the model 106.

The model update unit 302 may be configured to store model parameters from update to update to provide trend analysis capability for the model. Trending in any or all of the model parameters can indicate sensor drift or other factors that may give rise to, increase, or decrease model error over time.

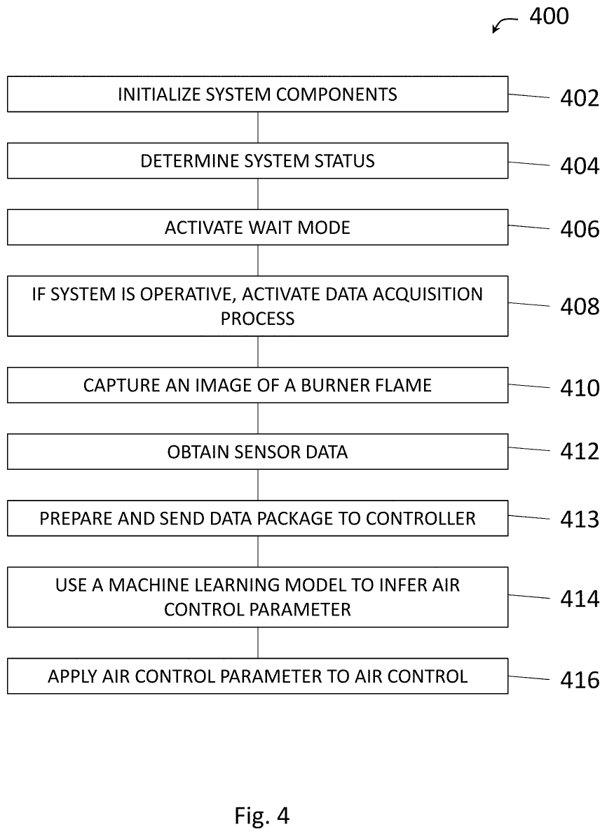

FIG. 4 is a flow diagram summarizing a method 400 according to another embodiment. The method 400 is a method of operating an autonomous control system for a hydrocarbon burner. At 402 system control devices are initialized to operating status. Signal connectivity to and from the various controllers, sensors, and imaging devices is evaluated and any defects noted and addressed. A controller is activated to control the system in an “autopilot” style mode, receiving input from the system control devices, computing control output, and sending the control output to system control devices. The “autopilot” mode maintains a nominal air flow to the burner according to a simple control scheme in order to provide a basis for starting the machine learning system. At 404, system status is determined. If the system is off, the method ends. If system flow indicators, for example oil pressure and air pressure, are not detectable (for example data readings near or at zero are obtained), an actuator can be operated to initialize flow of air and/or hydrocarbons to the burners. Upon initializing operation of the burner, a wait operation can optionally be activated at 406 for a predetermined amount of time, or until another condition is achieved, and the method 400 repeats starting at 402.

If it is determined that the system is in an operative state, for example if flow indication parameters indicate the system is operating (for example oil pressure and air pressure are not zero), a data acquisition process 408 is activated. At 410, one or more cameras capture an image of the burner flame. The image can be reduced to a data set by the camera, or by a digital processing system operatively coupled to the camera, as described elsewhere herein. At 412, a packet of sensor data is obtained from sensors of the burner control system. Data such as oil flow rate, gas flow rate, air flow rate, water or steam flow rate, temperature, pressure, wind speed, wind direction, humidity, air quality, and other factors can be included in the packet of sensor data.

At 413, a data package is prepared and sent to a controller. The data package is derived from digital processing of images received from the camera, and includes x-y coordinates with spectral intensity data, along with environmental, sensor, and control data in a time-stamped data structure.

At 414, the image and sensor data is sent to a controller. The controller uses a machine learning model, such as the neural network model described above, to infer an air control parameter such as valve open position, which is sent to an actuator for air control at 416. The actuator for air control adopts the valve open position sent by the controller, and then the wait process can optionally be activated until another image of the burner flame is captured. If another image of the burner flame is available, the method 400 may repeat immediately such that the control cycle is continuously active. The actuator for air control may be a pneumatically activated control valve or an electrically activated control valve.

A neural network model, as described herein, can be configured as a series of calculations using the input data to compute the value of a function based on model parameters. The model parameters can vary amongst the calculation nodes of the neural network model according to weighting factors and scores assigned by any convenient method. For example, each calculation node can take, as input, the data set from sensors and cameras, and a result from a prior calculation node, such as a score or error, that is applied to adjust the model parameters used in the prior calculation node. For example the error described above can be used as an error output of a calculation node of the neural network model. Each calculation node can thus improve or degrade the model result, receive commensurate scores, and be emphasized or de-emphasized for subsequent nodes of the network until an overall output of the neural network model is obtained.

The neural network model described herein can monitor burner operation through startup, shutdown, and continuous burning operations and can replicate through behavior cloning. When one model is trained and tested, and generates low errors when predicting air control, the model can be installed in a control loop and used to control a burner. The model can apply tolerances to the various inputs, noting certain signatures in the image data or sensor data that may indicate poor or deteriorating combustion, and can take corrective action, such as increasing or decreasing air flow, fuel flow, or air-to-fuel ratio. Monitoring image data allows the model to identify flame presence or absence, various types of smoke emission, water screens, flame quality, transitions, and flame volume changes. As the model operates, it can continuously improve by comparing acquired flame image data to standards, which can also be automatically determined. For example, if air quality adjacent to the burner is periodically examined, the model can apply air quality data to flame image data to correlate flame images to air quality. The model can then manipulate operating parameters to continually seek flame images that indicate the best air quality.

While the foregoing is directed to embodiments of the present invention, other and further embodiments of the present disclosure may be devised without departing from the basic scope thereof, and the scope thereof is determined by the claims that follow.

What is claimed is:

1. A method, comprising:
capturing an image of an operating burner;
processing the image to form an image data set;
capturing sensor data of the operating burner;
forming a data set comprising the sensor data and the image data set;
providing the data set to a machine learning model system;
outputting, from the machine learning model system, an air control parameter of the burner; and
applying the air control parameter to the burner.

2. The method of claim 1, wherein the image is a first image of a video, and the method is repeated for each image in the video.

3. The method of claim 2, wherein the video is a live video feed.

4. The method of claim 1, wherein processing the image to form the image data set includes one of normalizing the image data set, smoothing the image data set, and filtering the data set.

5. The method of claim 1, wherein the machine learning model system outputs a plurality of air control parameters.

6. The method of claim 5, further comprising identifying a change in any of the air control parameter outputs that is outside a tolerance.

7. The method of claim 5, wherein the image is a spectral brightness image at a plurality of wavelengths at visible and infrared wavelengths.

8. The method of claim 8, wherein the parameter is one of overall brightness across the spectrum, overall brightness at one or more selected wavelengths, and brightness variation at one or more selected wavelengths.

9. A burner control system, comprising:
an imaging system for capturing burner images as image data;
an image processing system comprising a digital processor with non-transitory medium containing instructions to perform a classification process on the image data representing images of the burner captured by the imaging system to produce classification data; and
a control system comprising a digital processor with non-transitory medium containing instructions to compute an air control action based on the classification data and a neural network burner model.

10. The burner control system of claim 9, wherein the imaging system is a broadband imaging system that captures spectral emissions of the burner in visible and infrared wavelengths.

11. The burner control system of claim 10, wherein the classification process is a brightness classification process.

12. The burner control system of claim 9, wherein the burner model receives spectral intensity data from the image processing system as input and produces an air control signal as output.

13. The burner control system of claim 12, wherein the neural network model further comprises an output testing section that compares the air control signal to one or more acceptance conditions.

14. The burner control system of claim 13, wherein one of the acceptance conditions is magnitude of change.

15. The burner control system of claim 9, wherein the neural network burner model outputs a plurality of air control actions.

16. The burner control system of claim 15, wherein the plurality of air control actions comprise set points for air flow rate, pressure, and temperature.

17. A method of controlling a burner, comprising:
capturing a broad-spectrum image of an operating burner;
processing the image to form an image data set including spectral content of each pixel of the image;
capturing sensor data of the operating burner;
forming a data set comprising the sensor data and the image data set;
providing the data set to a machine learning model system;
outputting, from the machine learning model system, an air control parameter of the burner;
applying the air control parameter to the burner;
comparing the image data to a standard to define a score; and
adjusting the machine learning model based on the score.

18. The method of claim 17, wherein the machine learning model outputs a plurality of air control parameters.

19. The method of claim 18, wherein the machine learning model is a neural network model, and adjusting the machine learning model based on the score comprises comparing the score to a standard to yield an error and adjusting edge values of the neural network according to the error.

20. The method of claim 17, wherein defining the score further comprises comparing the air control parameter output to a prior air control parameter.
